(19) United States
(12) Patent Application Publication
(10) Pub. No.: US 2006/0123069 A1
(43) Pub. Date: Jun. 8, 2006

(54) Method and system for deferred synchronisation of data

(75) Inventor: Andrew Ian Hickson, West Wellow (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/293,977

(22) Filed: Dec. 5, 2005

(30) Foreign Application Priority Data
Dec. 8, 2004 (GB) 0426848.8

(51) Int. Cl. G06F 17/30

(52) U.S. Cl. 707/205

(57) ABSTRACT

A method and a system of deferred synchronisation of data resulting from operations by applications (506) on a resource manager (501). The method includes receiving a request for an operation (511), identifying the operation as part of a synchronised transaction that has not yet started, completing the operation, subsequently starting the synchronised transaction (517) of which the completed operation is to be a part, and associating (519) the completed operation with the synchronised transaction (517). For example, the system may be an asynchronous messaging system with a plurality of distributed applications (506) getting and putting messages and the resource manager (501) is a queue manager. The operation (511) may be a get operation and the synchronised transaction (517) may be a unit of work.

### TECHNICAL FIELD

This invention relates to the field of synchronisation of data. In particular, this invention relates to deferred synchronisation of transactions, for example, in a an asynchronous messaging system.

### BACKGROUND OF THE INVENTION

Synchronisation of transactions is required to maintain data integrity. For example, a sale transaction comprises the subtraction of money from a customer's account and its addition to the retailer's account. The two halves of the transaction must both occur to maintain the data integrity. If the subtraction from the customer's account takes place, but an error occurs and the addition to the retailer's account does not take place, the whole transaction must be backed out. Therefore, the transaction is only confirmed or committed once all parts of the transaction have been completed.

This concept has wide reaching applications across data systems. Synchronisation of transactions is generally handled by a middle-tier application referred to here as a transaction coordinator. Data resources that require synchronisation may be distributed with connections via network communications. A transaction coordinator can synchronise related changes to multiple data resources: either all related changes occur, or they are all undone.

In messaging systems, changes to a message queue resource are treated in the same way as changes to other data resources such as databases. This invention is described in terms of messaging systems; however, it can be applied to other systems with distributed resources that require transaction coordination.

In a messaging system, the decision to commit or back out the changes is taken, in the simplest case, at the end of a transaction. However, it can be more useful for an application to synchronize data changes at other logical points within a transaction. These logical points are called syncpoints (or synchronisation points) and the period of processing a set of updates between two syncpoints is called a unit of work. Multiple messaging get and put operations can be part of a single unit of work.

When an application puts a message on a queue within a unit of work, that message is made visible to other applications only when the application commits the unit of work. To commit a unit of work, all updates must be successful to preserve data integrity. If the application detects an error and decides that the put operation should not be made permanent, it can back out the unit of work. When an application performs a back out, the system restores the queue by removing the messages that were put on the queue by that unit of work. The way in which the application performs the commit and back out operations depends on the environment in which the application is running.

Similarly, when an application gets a message from a queue within a unit of work, that message typically remains on the queue until the application commits the unit of work, but the message is marked as not available to be retrieved by other applications. The message is permanently deleted from the queue when the application commits the unit of work. If the application backs out the unit of work, the system restores the queue by making the messages available to be retrieved by other applications.

A single-phase commit process is one in which a single resource manager can commit updates without coordinating its changes with other resource managers. A two-phase commit process is one in which updates to multiple resource managers can be coordinated. (For example, between a queue manager and databases). Under such a process, updates to all resources are committed or backed out together.

A problem faced by asynchronous messaging applications using two-phase commit is that the application needs to start a syncpoint before issuing a request to get a message. If no message is immediately available, then the get request typically blocks until a message does become available. However, in the case where the syncpoint was started before the get was issued then blocking can cause a long running transaction that will typically cause the transaction to be asynchronously rolled back after some period of time.

Some applications browse the messages before starting the syncpoint but this can be very inefficient as an application must look at a message twice: once to wait for the message to become available, and a second time to get the message to process.

### SUMMARY OF THE INVENTION

An aim of the present invention is to allow one or more operations to be carried out before the start of the coordinated transaction of which the operations will be a part, and then to make the association later.

According to a first aspect of the present invention there is provided a method of deferred synchronisation of data resulting from operations by applications on a resource manager, comprising: receiving a request for an operation; identifying the operation as part of a synchronised transaction that has not yet started; completing the operation; subsequently starting the synchronised transaction of which the completed operation is to be a part; and associating the completed operation with the synchronised transaction.

A transaction may be synchronised across a plurality of distributed resource managers, for example, queue managers, databases, etc. and the operations may be requested by distributed applications.

A plurality of operations identified as part of a single synchronised transaction may be completed before starting the synchronised transaction.

The step of starting the synchronised transaction may be in response to a begin transaction request. Alternatively, the step of starting the synchronised transaction may be in response to a commit transaction request and includes committing the synchronised transaction including one or more completed operations associated with the synchronised transaction.

Preferably, the method is part of an asynchronous messaging process in which the operation is a get operation and the synchronised transaction is a unit of work. The step of identifying the operation as part of a synchronised transaction that has not yet started may be by means of an identifier also used to identify the unit of work, once started. The method may be provided by specifying an option in a get request to defer synchronisation. Changes resulting from the completed operation may be reserved and transferred to a log record once the unit of work is started.

A first application may transfer an active operation request to a second application that issues a begin transaction request to start the synchronised transaction of which the completed operation is to be a part.

According to a second aspect of the present invention there is provided a system of deferred synchronisation of data resulting from operations by applications on a resource manager, the system comprising: a resource manager including: means for receiving a request for an operation; means for identifying the operation as part of a synchronised transaction that has not yet started; means for completing the operation; a transaction coordinator starting the synchronised transaction of which the completed operation is to be a part; and means for associating the completed operation with the synchronised transaction.

Means may be provided for reserving changes caused by the completed operation and transferring the changes to a log record once the transaction is started.

The transaction coordinator may be the resource manager or, alternatively, may be separate from the resource manager. A transaction may be synchronised across a plurality of distributed resource managers, for example, queue managers, databases, etc. and the operations may be requested by distributed applications.

Preferably, the system is an asynchronous messaging system with a plurality of distributed applications getting and putting messages and the resource manager is a queue manager. The operation may be a get operation and the synchronised transaction may be a unit of work. The get operation may specify an option to defer synchronisation.

The means for identifying the operation as part of a synchronised transaction that has not yet started may be an identifier also used to identify the unit of work, once started. The means for identifying the operation as part of a synchronised transaction may be one of a connection handle, a unit of work handle or a message handle.

A first application may include means to transfer an active operation request to a second application that issues a begin transaction request to start the synchronised transaction of which the completed operation is to be a part. The means to transfer an active operation request may include transferring an operation identifier. The operation identifier may be a unit of work handle or a message handle.

According to a third aspect of the present invention there is provided a computer program product stored on a computer readable storage medium, comprising computer readable program code means for performing the steps of: receiving a request for an operation; identifying the operation as part of a synchronised transaction that has not yet started; completing the operation; subsequently starting the synchronised transaction of which the completed operation is to be a part; and associating the completed operation with the synchronised transaction.

### BRIEF DESCRIPTION OF THE DRAWING

Embodiments of the present invention will now be described, by way of examples only, with reference to the accompanying drawings in which:

FIG. 1 is a block diagram of a computer system with a plurality of resource managers with a transaction coordinator to which the present invention may be applied;

FIG. 2 is a block diagram of a messaging system with multiple queue managers to which the present invention may be applied;

FIG. 3 is a message flow diagram of a transaction start procedure as known in the prior art:

FIG. 4 is a message flow diagram of a browse and get procedure as known in the prior art;

FIGS. 5A to 5C are message flow diagrams of three embodiments of a method of deferring synchronisation of operations in accordance with the present invention; and

FIG. 6 is a block diagram of a messaging system in which a handle for synchronisation can be passed between applications in accordance with an aspect of the present invention.

### DETAILED DESCRIPTION

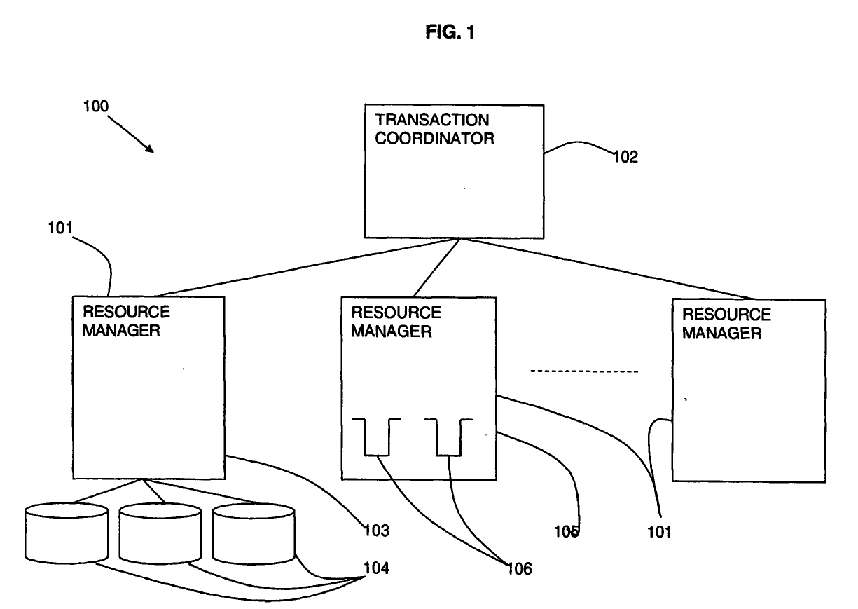

Referring to FIG. 1, a generalized system 100 is shown with a plurality of resource managers 101 and a transaction coordinator 102. The resource managers 101 may be in the form of a database manager 103 with database resources 104. Another form of resource manager 101 may be a queue manager 105 in a messaging system in which the data resources are queues 106. The transaction coordinator 102 may be part of a resource manager 101. The transaction coordinator 102 synchronises transactions to maintain data integrity.

The embodiments described herein are given in the context of a messaging environment, specifically WebSphere MQ messaging (formerly known as MQSeries. WebSphere and MQSeries are trade marks of International Business Machines Corporation). Details of WebSphere MQ messaging are provided at http://www.ibm.com/software/integration/wmq. The invention could equally be applied to other applications and environments in which data integrity is preserved by means of synchronisation points.

Messaging and queuing enables applications to communicate without having a private connection to link them. Applications communicate by putting messages on message queues and by taking messages from message queues. The communicating applications may be running on distributed computer systems. There are many messaging system architectures and the type of architecture is not relevant to the invention.

A message queue is a named destination to which messages can be sent. Messages accumulate on queues until they are retrieved by applications that service those queues. Queues reside in and are managed by a queue manager. A queue can be, for example, a volatile buffer area in memory of a computer, or a data set on a permanent storage device. The physical management of the queues is the responsibility of the queue manager and is not made apparent to the participating applications. Applications access queues through the external services of the queue manager. They can open a queue, put messages on it, get messages from it, close the queue, etc.

Many different applications can make use of the queue manager's services at the same time and these applications can be related. For an application to use the services of a queue manager it must establish a connection to that queue manager.

For applications to be able to send messages to applications that are connected to other queue managers, the queue managers must be able to communicate among themselves.

Queue managers can be connected through various forms of architecture. A cluster is a network of queue managers that are logically associated and the queues that they host are available to the other queue managers in the cluster. Distributed queuing can also be provided without clustering and every queue manager is independent with defined transmission queues and channels between the queue managers.

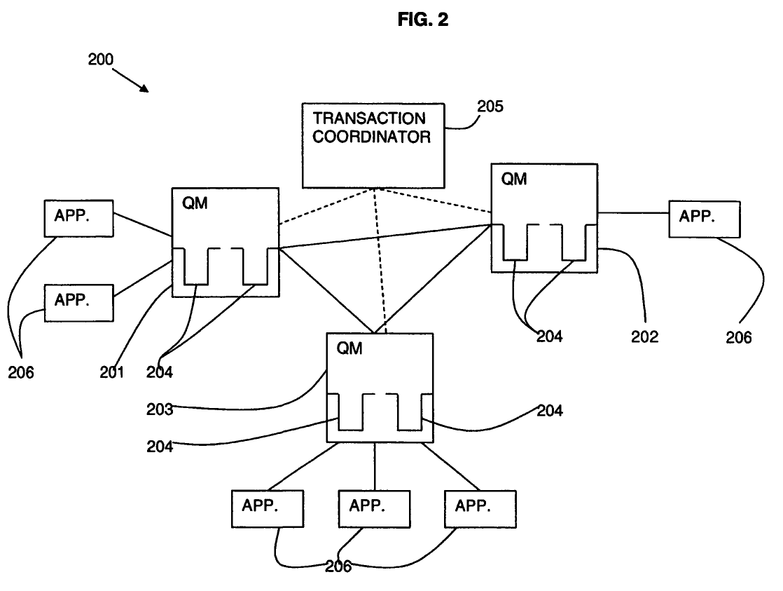

FIG. 2 is a generalised representation of a messaging system 200 with a plurality of connected queue managers 201, 202, 203. Each queue manager 201, 202, 203 has resources in the form of queues 204. Applications 206 are connected to one of the queue managers 201, 202, 203 and send and receive messages to that queue manager. There need not be a direct connection between applications that communicate using message queues. An application sends messages to a queue owned by a queue manager and another application retrieves messages from a queue.

A transaction coordinator 205 (also referred to in messaging systems as a syncpoint manager) is provided for synchronising transactions across the queues 204. The queue managers 201, 202, 203 defer commitment of changes made to queues until all the parties to a transaction can commit.

The form of messaging may vary with different systems including point to point messaging and publish/subscribe systems.

An application talks directly to a connected queue manager using an interface. The described embodiments use the Message Queue Interface (MQI) as an example; however, corresponding commands are provided in other messaging systems and in other transaction based systems. The MOI is a set of calls that applications use to ask for the services of a queue manager.

The calls in the MQI can be grouped as follows:

MQCONN, MQCONNX, and MQDISC—These calls are used to connect an application to, and disconnect an application from, a queue manager. The MQCONNX call is similar to the MQCONN call, but includes options to control the way that the call actually works.

MQOPEN and MQCLOSE—These calls are used to open and close an object, such as a queue.

MQPUT and MQPUT1—These calls are used to put a message on a queue.

MQGET—This call is used to browse messages on a queue, or to remove messages from a queue.

Options are provided to control the action of a get operation. One of the options that may be specified with a get operation is an option to wait for messages to arrive on the queue. A maximum time the application waits is specified as a wait interval.

Another form of option relates to the participation of the get operation within a unit of work. A get operation can be specified with syncpoint control in which case the get request operates within the normal unit of work protocols. A message is marked as being unavailable to other applications, but it is deleted from the queue only when the unit of work is committed. The message is made available again if the unit of work is backed out.

MQINQ—This call is used to inquire about the attributes of an object.

MQSET—This call is used to set some of the attributes of an object.

MOBEGIN, MQCMIT, and MQBACK—These calls are used when coordinating a unit of work. MQBEGIN starts a global unit of work. MQCMIT and MQBACK end the unit of work, either committing or rolling back the updates made during the unit of work.

An connection handle (hConn) is a unique identifier for an application to communicate with a queue manager. A connection handle is returned by the MQCONN or MQCONNX call when an application connects to the queue manager. Applications pass the connection handle as an input parameter when using other calls.

As discussed in the preamble, syncpoint coordination is the process by which units of work are either committed or backed out with data integrity.

A local unit of work is one in which the only resources updated are those of the connected queue manager. Here syncpoint coordination is provided by the queue manager itself using a single-phase commit procedure.

A global unit of work is one in which resources belonging to other resource managers, such as databases, are also updated. The transaction coordination may be internal or external to the queue manager. For full integrity, a two-phase commit procedure must be used. Two-phase commit can be provided by XA-compliant transaction managers and databases.

When the queue manager is the transaction coordinator, the transaction coordination is internal in that it is performed by the queue manager. To start a global unit of work, the application issues a begin call. As input to the begin call, a connection handle must be supplied. A connection handle is returned by a connection call (a MQCONN or MQCONNX call) of the application to the queue manager and this handle represents the connection to the queue manager.

The application issues get or put requests specifying the appropriate syncpoint option. This means that begin call can be used to initiate a global unit of work that updates local resources, resources belonging to other resource managers, or both. Updates made to resources belonging to other resource managers are made using the API of that resource manager. A commit or back out call must be issued before starting further units of work.

The global unit of work is committed using a commit call; this initiates a two-phase commit of all the resource managers involved in the unit of work. In the two-phase commit process, resource managers (for example, XA-compliant database managers such as DB2(R), Oracle, and Sybase) are firstly all asked to prepare to commit, only if all are prepared are they asked to commit. If any resource manager signals that it votes no on the prepare to commit call, each is asked to back out instead. Alternatively, a back out call can be used to roll back the updates of all the resource managers.

If a transaction coordinator is other than the queue manager, external transaction coordination is performed. In this situation, the resource managers register their interest in the outcome of the unit of work with the transaction coordinator so that they can commit or roll back any uncommitted get or put operations as required.

!@#$The scope of the unit of work is determined by the transaction coordinator. The state of the connection between the application and the queue manager affects the success or failure of calls that an application issues, not the state of the unit of work. It is, for example, possible for an application to disconnect and reconnect to a queue manager during an active unit of work and perform further get and put operations inside the same unit of work.

The following is an example of the process carried out by a resource manager acting as a transaction coordinator:

1. An application notifies the transaction coordinator that it wishes to start a transaction.

2. The transaction coordinator issues a call to any resource managers that it knows of, to notify them of the current transaction.

3. The application issues calls to update the resources managed by the resource managers associated with the current transaction.

4. The application requests that the transaction coordinator either commit or roll back the transaction.

5. The transaction coordinator issues calls to each resource manager using two-phase commit protocols to complete the transaction as requested.

In prior art systems a problem arises with two-phase commit in asynchronous messaging. The application needs to start a syncpoint before issuing a request to get a message.

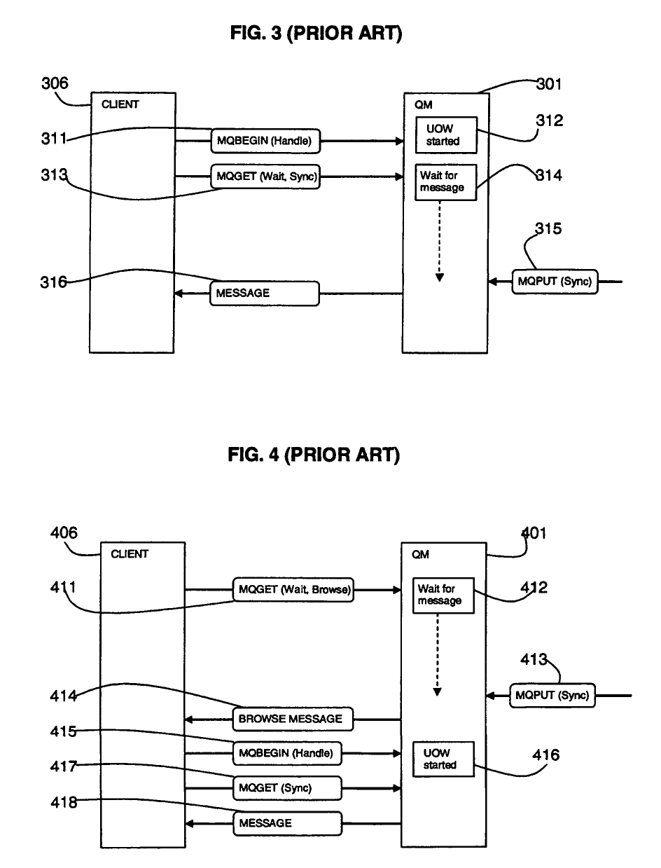

A message flow of a prior art syncpoint get operation is shown in FIG. 3. An application 306 issues a begin request 311 with a connection handle specified, to a queue manager 301. A unit of work 312 is started at the queue manager 301. The application 306 then issues a get request 313 with specified options of waiting and syncpoint coordination with the unit of work 312. The get request waits 314 for a message to arrive at the queue. A message arrives with a put request 315 from another application and the message 316 can then be returned to the application 306.

This form of message flow has the disadvantage that if no message is immediately available, the get request typically blocks until a message does become available. In the case where the syncpoint is started before the get request is issued then the blocking can cause a long running transaction that will typically cause the transaction to be asynchronously rolled back after some period of time.

FIG. 4 shows an alternative prior art method in which an application browses messages before starting the syncpoint. An application 406 sends a get browse request 411 to the queue manager 401 with an option to wait 412 for a message. When a message arrives with a put request 413 from another application, the message is browsed 414 by the application 406. A begin request 415 is then issued with a connection handle specified and a unit of work 416 is started. A get request 417 is issued with specified syncpoint coordination with the unit of work 416 and the message is returned 418 to the application 406.

This form of message flow is inefficient as the message is returned twice to the application 406, once to browse it and a second time to get it.

The present invention provides a new option on a get operation referred to as a deferred syncpoint option. This option enables one or more operations to be carried out specifying a deferred syncpoint before a unit of work has been started.

A deferred syncpoint has a handle that is used to identify the deferred syncpoint and this is referred to by operations prior to the unit of work starting. Any messages that are returned with the deferred syncpoint option are reserved by the resource manager. The handle used to identify the deferral of work may be a connection handle, a message handle or a unit of work handle.

Typically, a log record is written at the time of a get request and a unit of work is identified in the log record to associate an operation with the unit of work. In the present process, the writing of the log record is deferred until the unit of work is started.

Typically, when a unit of work is started the log record is written including the unit of work identifier. The unit of work identifier is not known until the syncpoint has started. In the present process, once the unit of work has been started, the reserved messages are then transferred to the log record in association with the unit of work.

The handle that is used for the deferred syncpoint operations is specified at the begin operation for the unit of work and every deferred operation on the handle is moved to the unit of work.

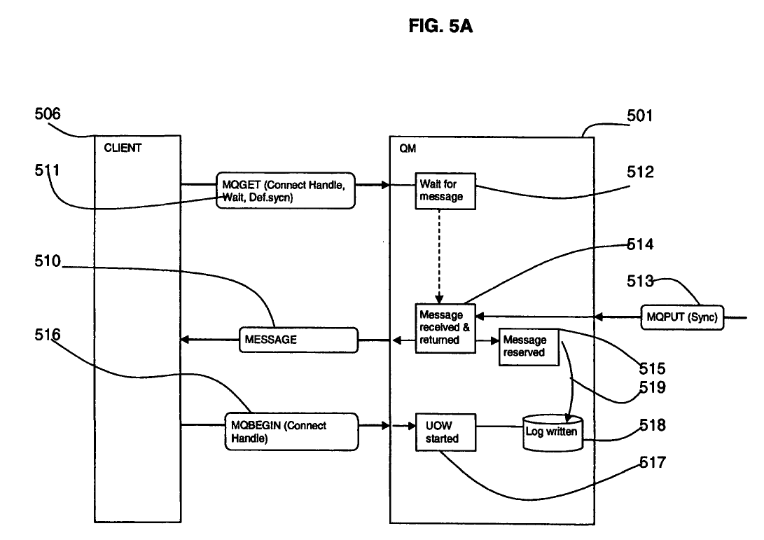

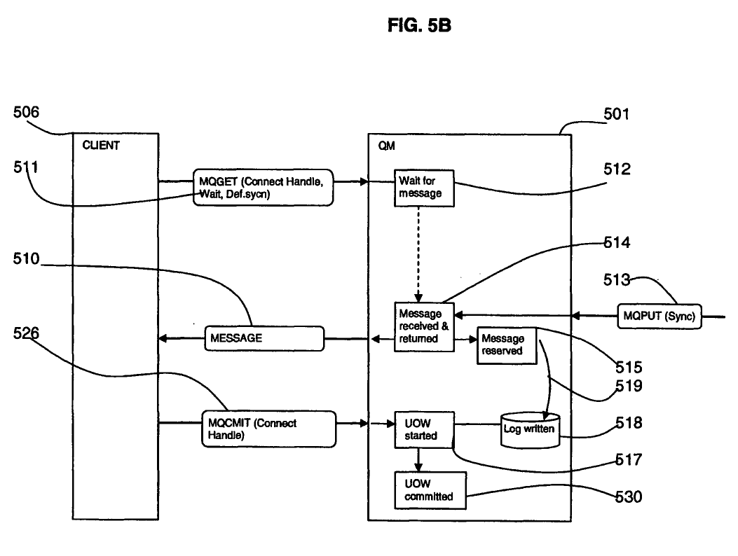

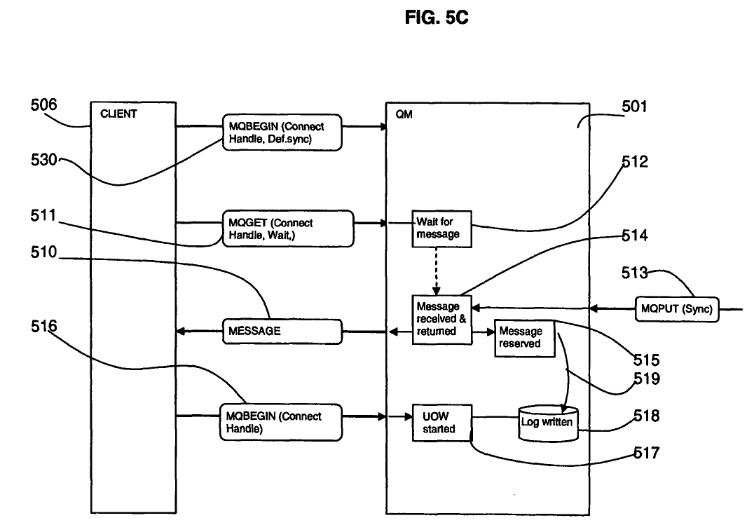

FIG. 5A shows a message flow in accordance with a first embodiment of the present invention. An application 506 issues a get request 511 to the queue manager 501. The get request 511 specifies a connection handle, a wait period and a deferred syncpoint option. The get request 511 waits 512 for a message. When a message is put 513 on the queue, the message 510 is returned 514 to the application 506 and reserved 515. More than one get request may be carried out in this way within the same deferred syncpoint.

A begin request 516 is issued specifying the same connection handle for the deferred syncpoint. A unit of work 517 is started for the deferred syncpoint and a corresponding log record 518 is written. All messages marked as in a deferred syncpoint associated with the current connection handle are moved 519 into the new transaction and logged. Thus, the state of the new transaction is as it would have been if the transaction had been started before issuing the initial get operation 511.

In an MQ messaging system, the MOGET option MQGMO_SYNCPOINT_DEFERRED is provided. When an MQGET with MQGMO_SYNCPOINT_DEFERRED is issued, then when a message becomes available it is returned to the application, marked as in a deferred syncpoint associated with the current connection handle, and log space is reserved for an MQGET log record.

FIG. 5B shows a message flow in accordance with a second embodiment of the present invention. The message flow is generally similar to that of FIG. 5A; however, instead of the begin request 516 being issued, a commit request 526 is issued.

The commit request 526 is issued specifying the same connection handle for the deferred syncpoint. A unit of work 517 is started with a corresponding log record 518. All messages marked as in a deferred syncpoint associated with the current connection handle are moved 519 into the new transaction and logged. Thus, the state of the new transaction is as it would have been if the transaction had been started before issuing the initial get operation 511. The unit of work 517 is then committed 530. A single commit request 526 has the effect of starting a unit of work, transferring all deferred syncpoint operations to the unit of work and committing the unit of work.

FIG. 5C shows a message flow in accordance with a third embodiment of the present invention. This message flow is similar to that of FIG. 5A with the addition of a begin request 530 issued by the application 506 to begin a deferred unit of work. The begin request 530 uses a connection handle and specifies a deferred syncpoint. The queue manager 501 can optionally return a unit of work handle to identify the deferred work. A subsequent get request 511 from the application 506 can be associated with the deferred syncpoint specified by the begin request 530 by using the connection handle. A begin request 516 is then sent by the application 506 to start the unit of work 517 and the begin request 516 identifies the connection handle.

An additional feature of the described method is that a unit of work handle or a message handle can be passed explicitly between applications. A unit of work handle or a message handle for a get operation can be transferred to another application for use with a begin operation. This may be required if one application reads a queue on behalf of other one or more applications.

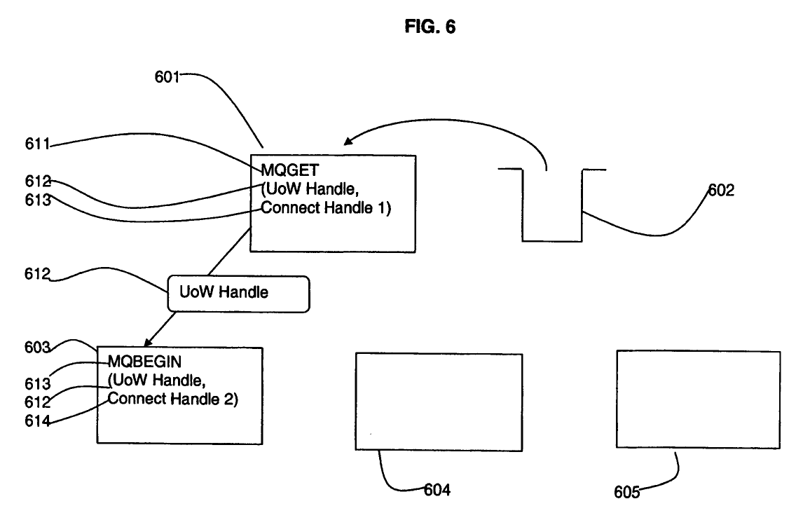

FIG. 6 shows a first application 601 that reads a queue 602 on behalf of other applications 603, 604, 605. The first application 601 issues a begin operation with deferred syncpoint with a specified connection handle. The queue manager returns a deferred unit of work handle to the first application 601. The first application 601 then carries out a get operation 611. The get operation 611 specifies the connection handle 613 and the unit of work handle 612.

The unit of work handle 612 can be explicitly passed to another application 603, 604, 605 to begin the deferred unit of work. In this case, the unit of work handle 612 is passed to the second application 603 that can issue a begin operation 613 with its own connection handle 614 and specifying the unit or work handle 612 for the deferred work. A message handle could also be passed between operations in a similar way.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

I claim:

1. A method of deferred synchronisation of data resulting from operations by applications on a resource manager, comprising:
receiving a request for an operation;
identifying the operation as part of a synchronised transaction which has not yet started;
completing the operation;
subsequently starting the synchronised transaction of which the completed operation is to be a part; and
associating the completed operation with the synchronised transaction.

2. A method as claimed in claim 1, wherein a plurality of operations identified as part of a single synchronised transaction can be completed before starting the synchronised transaction.

3. A method as claimed in claim 1, wherein the step of starting the synchronised transaction is in response to a begin transaction request.

4. A method as claimed in claim 1, wherein the step of starting the synchronised transaction is in response to a commit transaction request and includes committing the synchronised transaction including one or more completed operations associated with the synchronised transaction.

5. A method as claimed in claim 1, wherein the method is part of an asynchronous messaging process.

6. A method as claimed in claim 5, wherein the operation is a get operation and the synchronised transaction is a unit of work.

7. A method as claimed in claim 6, wherein the step of identifying the operation as part of a synchronised transaction which has not yet started is by means of an identifier also used to identify the unit of work, once started.

8. A method as claimed in claim 6, wherein the method is provided by specifying an option in a get request to defer synchronisation.

9. A method as claimed in claim 6, wherein changes resulting from the completed operation are reserved and transferred to a log record once the unit of work is started.

10. A method as claimed in claim 1, wherein a first application transfers an active operation request to a second application which issues a begin transaction request to start the synchronised transaction of which the completed operation is to be a part.

11. A system of deferred synchronisation of data resulting from operations by applications on a resource manager, the system comprising:
a resource manager including:
means for receiving a request for an operation;
means for identifying the operation as part of a synchronised transaction which has not yet started;
means for completing the operation;
a transaction coordinator starting the synchronised transaction of which the completed operation is to be a part; and
means for associating the completed operation with the synchronised transaction.

12. A system as claimed in claim 11, wherein means are provided for reserving changes caused by the completed operation and transferring the changes to a log record once the transaction is started.

13. A system as claimed in claim 11, wherein the transaction coordinator is the resource manager.

14. A system as claimed in claim 11, wherein the transaction coordinator is separate from the resource manager.

15. A system as claimed in claim 11, wherein the system is an asynchronous messaging system with a plurality of distributed applications getting and putting messages and the resource manager is a queue manager.

16. A system as claimed in claim 15, wherein the operation is a get operation and the synchronised transaction is a unit of work.

17. A system as claimed in claim 16, wherein the means for identifying the operation as part of a synchronised transaction which has not yet started is an identifier also used to identify the unit of work, once started.

18. A system as claimed in claim 16, wherein the means for identifying the operation as part of a synchronised transaction is one of a connection handle, a unit of work handle or a message handle.

19. A system as claimed in claim 16, wherein the get operation specifies an option to defer synchronisation.

20. A system as claimed in claim 11, wherein a first application includes means to transfer an active operation request to a second application which issues a begin transaction request to start the synchronised transaction of which the completed operation is to be a part.

21. A system as claimed in claim 20, wherein the means to transfer an active operation request includes transferring an operation identifier.

22. A system as claimed in claim 21, wherein the operation identifier is a unit of work handle or a message handle.

23. A computer program product stored on a computer readable storage medium, comprising computer readable program code means for performing the steps of:
receiving a request for an operation;
identifying the operation as part of a synchronised transaction which has not yet started;
completing the operation;
subsequently starting the synchronised transaction of which the completed operation is to be a part; and
associating the completed operation with the synchronised transaction.
